(19) United States
(12) Patent Application Publication
(10) Pub. No.: US 2026/0241430 A1
(43) Pub. Date: Aug. 20, 2026

(54) PRESS FORMING METHOD FOR METAL PLATE AND PRESS APPARATUS

(71) Applicant: Honda Motor Co., Ltd., Tokyo (JP)

(72) Inventors: Yasuhide Fukushima, Saitama (JP); Kunihiko Seki, Saitama (JP); Shun Hattori, Saitama (JP); Yuichi Hori, Saitama (JP); Takashi Goto, Saitama (JP); Takeshi Ohori, Saitama (JP)

(21) Appl. No.: 19/160,749

(22) PCT Filed: Feb. 20, 2024
(86) PCT No.: PCT/JP2024/005967

§ 371 Date: Aug. 28, 2025

(30) Foreign Application Priority Data
Mar. 3, 2023 (JP) 2023-032438

(51) Int. Cl. B21D 13/02; B21D 22/02; H01M 8/0202

(52) U.S. Cl. CPC B21D 13/02; B21D 22/02; H01M 8/0202

(57) ABSTRACT

A press forming method for a metal plate includes a pre-forming step of pressing a metal plate (100) with a convex curved surface (41, 51) to form a bulging portion (C1, C2) having a pressed region (R13, R 23) pressed by the convex curved surface (41, 51) in a top portion, and a shape forming step of pressing outer regions on both sides of the pressed region (R13, R23) in the bulging portion (C1, C2) to form the metal plate having the flattened top portion (81, 82), and a side wall portion (83) contiguous to the top portion (81, 82) and not subjected to pressing.

### CROSS-REFERENCE TO RELATED APPLICATION

This application is a National Stage of PCT international application Ser. No. PCT/JP 2024/005967 filed on Feb. 20, 2024 which designates the United States, incorporated herein by reference, and which is based upon and claims the benefit of priority from Japanese Patent Application No. 2023-032438, filed on Mar. 3, 2023, the entire contents of which are incorporated herein by reference.

### TECHNICAL FIELD

The present invention relates to a press forming method for a metal plate and a press apparatus.

### BACKGROUND ART

In general, a separator for a fuel cell is provided with a corrugated channel section that forms gas flow paths for the fuel gas and oxidant gas. One known method for forming the corrugated channel is press-forming a metal plate by using a press mold including a die and a punch (for example, see Patent Literature 1).

The forming method described in Patent Literature 1 first includes pressing a metal sheet with the tip of the punch to create a bulging portion, and then forming a projection by extending the side wall of the bulging portion while sandwiching the bulging portion between the inclined surfaces of the die and the punch. In other words, a single pressing process forms the bulging portion through stretch-forming and then creates the projection by extending the side wall of that bulging portion.

### CITATION LIST

### Patent Literature

Patent Literature 1: Japanese Examined Patent Publication No. 5573511

### DISCLOSURE OF INVENTION

### Problems to be Solved by the Invention

However, in the above-described forming method, the side wall of the bulging portion is further extended by pressing, which makes it prone to thinning. As a result, cracks or deformations (such as waviness) are likely to occur between the bulging portion and the thinned side wall portion. Consequently, it has been difficult to control the wall thickness of the product, and omitting wall thickness inspection has been challenging.

### Means for Solving Problem

An aspect of the present invention is a press forming method for a metal plate including a pre-forming step of pressing a metal plate with a convex curved surface to form a bulging portion having a top in a pressed region pressed by the convex curved surface, and a shape forming step of pressing outer regions on both sides of the pressed region in the bulging portion to flatten the top portion, and forming the flattened top portion and a side wall portion contiguous to the top portion and not subjected to pressing.

### Effect of the Invention

According to the present invention, it is possible to improve the forming accuracy in press forming.

### BRIEF DESCRIPTION OF THE DRAWINGS

FIG. 1 is an exploded perspective view schematically illustrating a configuration of a power generation cell of a fuel cell.

FIG. 2 is a cross-sectional view taken along line A-A in FIG. 1.

FIG. 3 is a diagram illustrating a cross-sectional shape of a first press mold used in a pre-forming process.

FIG. 4 is a diagram illustrating a pressing state during the pre-forming process.

FIG. 5 is a diagram illustrating another pressing state during the pre-forming process.

FIG. 6 is a diagram illustrating a final pressing state during the pre-forming process.

FIG. 7 is a diagram illustrating a cross-sectional shape of a second press mold used in a shape forming process.

FIG. 8 is a diagram illustrating a final pressing state during the shape forming process.

### DESCRIPTION OF EMBODIMENT

Hereinafter, embodiments of the present invention will be described with reference to the drawings. The following description and drawings are examples for describing the present invention, and omissions and simplifications are made as appropriate for the sake of clarity of the description. In addition, in the following description, the same or similar elements and processes are denoted by the same reference numerals, and overlapping descriptions will be omitted, in some cases. Note that the contents to be described below are merely examples of embodiments in the present invention, and the present invention is not limited to the following embodiments, and can be implemented in other various modes.

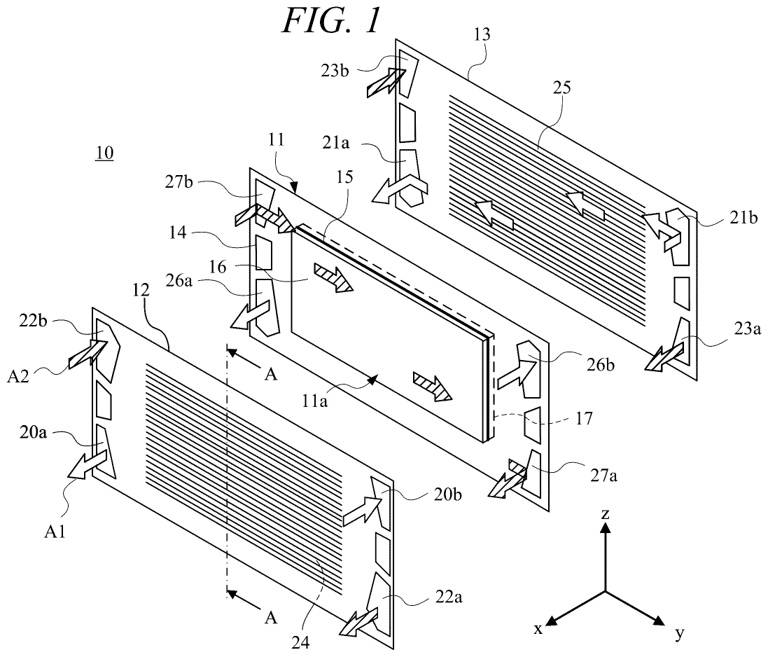

A press forming method of a metal plate according to an embodiment of the present invention is applicable to a power generation cell in a fuel cell stack mounted on a fuel cell vehicle such as a fuel cell automobile. FIG. 1 is an exploded perspective view schematically illustrating a configuration of a single power generation cell 10 for use in a fuel cell stack. The fuel cell stack is configured by stacking a plurality of power generation cells. Of the three orthogonal axes in FIG. 1, x-axis direction denotes the stacking direction of the power generation cells. The power generation cell 10 includes a unitized electrode assembly (UEA) 11, and a first separator 12 and a second separator 13 which are respectively disposed on both sides of the unitized electrode assembly 11. In FIG. 1, an arrow A1 (hollow arrow) indicates the flow of an oxidant gas, and an arrow A2 (hatched arrow) indicates the flow of a fuel gas.

The first separator 12 and the second separator 13 are formed by press forming a thin metal plate. As the thin metal plate, for example, a steel plate, a stainless steel plate, an aluminum plate, a titanium thin plate, or a thin metal plate obtained by conducting a surface treatment for corrosion prevention on them is used.

The unitized electrode assembly 11 includes a membrane electrode assembly (MEA) 11a, and a frame member 14 joined to a peripheral edge portion of the membrane electrode assembly 11a. The membrane electrode assembly 11a includes an electrolyte membrane 15, an anode electrode 16 provided on one surface of the electrolyte membrane 15, and a cathode electrode 17 provided on the other surface of the electrolyte membrane 15.

The frame member 14 is a frame member having a rectangular annular shape, in which a rectangular opening having substantially an identical shape to the membrane electrode assembly 11a having a rectangular shape is formed. The anode electrode 16 and the cathode electrode 17 are disposed to sandwich a rectangular opening edge portion of the frame member 14 at their outer peripheral edge portions, and are joined to the frame member 14 with an adhesive or the like. For example, the rectangular opening edge portion of the frame member 14 is disposed to be sandwiched between the cathode electrode 17 and the surface of the electrolyte membrane 15 on which the cathode electrode 17 is provided, and is joined to the electrolyte membrane 15 and the cathode electrode 17.

In the first separator 12, an oxidant gas outlet communication hole 20a, an oxidant gas inlet communication hole 20b, a fuel gas outlet communication hole 22a, and a fuel gas inlet communication hole 22b are provided. The oxidant gas outlet communication hole 20a and the fuel gas inlet communication hole 22b are disposed in alignment with each other in z direction at one end portion (minus side) of the first separator 12 in y direction. The oxidant gas inlet communication hole 20b and the fuel gas outlet communication hole 22a are disposed in alignment with each other in z direction at the other end portion (plus side) of the first separator 12 in y direction.

In the second separator 13, an oxidant gas outlet communication hole 21a, an oxidant gas inlet communication hole 21b, a fuel gas outlet communication hole 23a, and a fuel gas inlet communication hole 23b are provided. The oxidant gas outlet communication hole 21a and the fuel gas inlet communication hole 23b are disposed in alignment with each other in z direction at one end portion (minus side) of the second separator 13 in y direction. The oxidant gas inlet communication hole 21b and the fuel gas outlet communication hole 23a are disposed in alignment with each other in z direction at the other end portion (plus side) of the second separator 13 in y direction.

In the frame member 14, an oxidant gas outlet communication hole 26a, an oxidant gas inlet communication hole 26b, a fuel gas outlet communication hole 27a, and a fuel gas inlet communication hole 27b are provided. The oxidant gas outlet communication hole 26a and the fuel gas inlet communication hole 27b are disposed in alignment with each other in z direction at one end portion (minus side) of the frame member 14 in y direction. The oxidant gas inlet communication hole 26b and the fuel gas outlet communication hole 27a are disposed in alignment with each other in z direction at the other end portion (plus side) of the frame member 14 in y direction.

The oxidant gas outlet communication hole 20a and the oxidant gas inlet communication hole 20b of the first separator 12, and the oxidant gas outlet communication hole 21a and the oxidant gas inlet communication hole 21b of the second separator 13 are disposed to face each other respectively interposing the oxidant gas outlet communication hole 26a and the oxidant gas inlet communication hole 26b of the frame member 14 between them. The fuel gas outlet communication hole 22a and the fuel gas inlet communication hole 22b of the first separator 12, and the fuel gas outlet communication hole 23a and the fuel gas inlet communication hole 23b of the second separator 13 are disposed to face each other respectively interposing the fuel gas outlet communication hole 27a and the fuel gas inlet communication hole 27b of the frame member 14 between them.

Note that in the first separator 12, the second separator 13, and the frame member 14, cooling medium outlet communication holes and cooling medium inlet communication holes are respectively formed between the communication holes 22b, 23b, and 27b and the communication holes 20a, 21a, and 26a, and between the communication holes 20b, 21b, and 26b and the communication holes 22a, 23a, and 27a. The first separator 12 and the second separator 13 are each formed by joining outer peripheral edge portions of a pair of thin plates by welding or the like. The cooling medium flows inside the first separator 12 (between the pair of thin plates) and inside the second separator 13 along y direction.

An uneven groove surface 24, which extends in y direction, is formed on a surface, facing the unitized electrode assembly 11, in the first separator 12. The uneven groove surface 24 forms a fuel gas flow passage that communicates with the fuel gas inlet communication hole 22b and the fuel gas outlet communication hole 22a between the first separator 12 and the unitized electrode assembly 11.

Similarly, an uneven groove surface 25, which extends in y direction, is formed on a surface, facing the unitized electrode assembly 11, in the second separator 13. The uneven groove surface 25 forms an oxidant gas flow passage that communicates with the oxidant gas inlet communication hole 21b and the oxidant gas outlet communication hole 21a between the second separator 13 and the unitized electrode assembly 11.

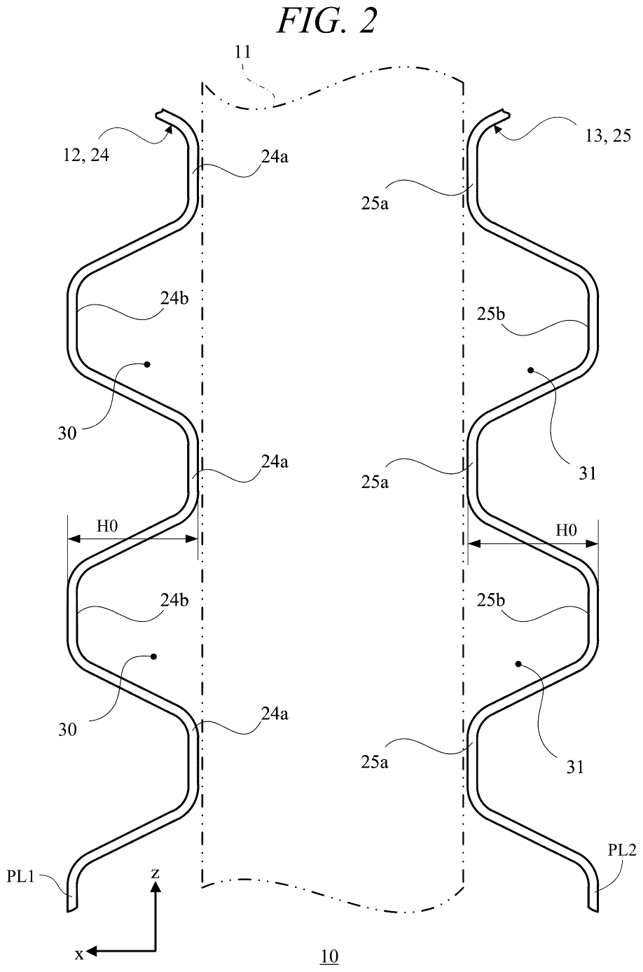

FIG. 2 is a part of a cross-sectional view taken along line A-A of the power generation cell 10 illustrated in FIG. 1, and is a cross-sectional view of the uneven groove surfaces 24 and 25 of first separator 12 and second separator 13. The separators 12 and 13 are each formed by joining a pair of thin plates PL1 and PL2, and FIG. 2 illustrates the thin plate PL1 on one side (the unitized electrode assembly 11 side) of the first separator 12 and the thin plate PL2 on one side (the unitized electrode assembly 11 side) of the second separator 13.

The uneven groove surfaces 24 and 25 are each formed by press forming. On the uneven groove surface 24 of the first separator 12 (the thin plate PL1), a plurality of protrusion portions 24a and recess portions 24b, which extend in y direction, are alternately formed in z direction. A fuel gas flow passage 30 is formed between the recess portions 24b and opposing surfaces of the unitized electrode assembly 11. Similarly, on the uneven groove surface 25 of the second separator 13 (the thin plate PL2), a plurality of protrusion portions 25a and recess portions 25b, which extend in y direction, are alternately formed in z direction. An oxidant gas flow passage 31 is formed between the recess portions 25b and opposing surfaces of the unitized electrode assembly 11.

Note that in FIG. 2, on the opposite side of the thin plate PL1 of the first separator 12 from the fuel gas flow passage 30, a cooling flow passage is formed by the protrusion portions 24a, and the cooling medium flows along the cooling flow passage. Similarly, on the opposite side of the thin plate PL2 of the second separator 13 from the oxidant gas flow passage 31, a cooling flow passage is formed by the protrusion portions 25a, and the cooling medium flows along the cooling flow passage.

The thin plate PL1 and the thin plate PL2 are identical in shape to each other. In a case where the thin plate PL1 is inverted in x-axis direction, it becomes the thin plate PL2. In addition, the protrusion portions 24a and 25a and the recess portions 24b and 25b are identical in shape to each other. In a case where the protrusion portions 24a and 25a are inverted in x-axis direction, they become the recess portions 24b and 25b. However, the thin plate PL1 and the thin plate PL2, and the protrusion portions 24a and 25a and the recess portions 24b and 25b may not be necessarily identical in shape to each other. The plate thickness of the thin plates PL1 and PL2 respectively used for the first and second separators 12 and 13 is, for example, approximately 0.1 mm. In addition, the pitch (the interval in z direction) of the recess portions 24b and 25b is, for example, approximately 1 mm, and the height (a width in x direction) of an uneven part is, for example, approximately 0.5 mm.

The first separator 12 and the second separator 13 are each formed by press forming a thin metal plate. The press forming method in the present embodiment includes a pre-forming process and a shape forming process.

### Configuration of First Press Mold

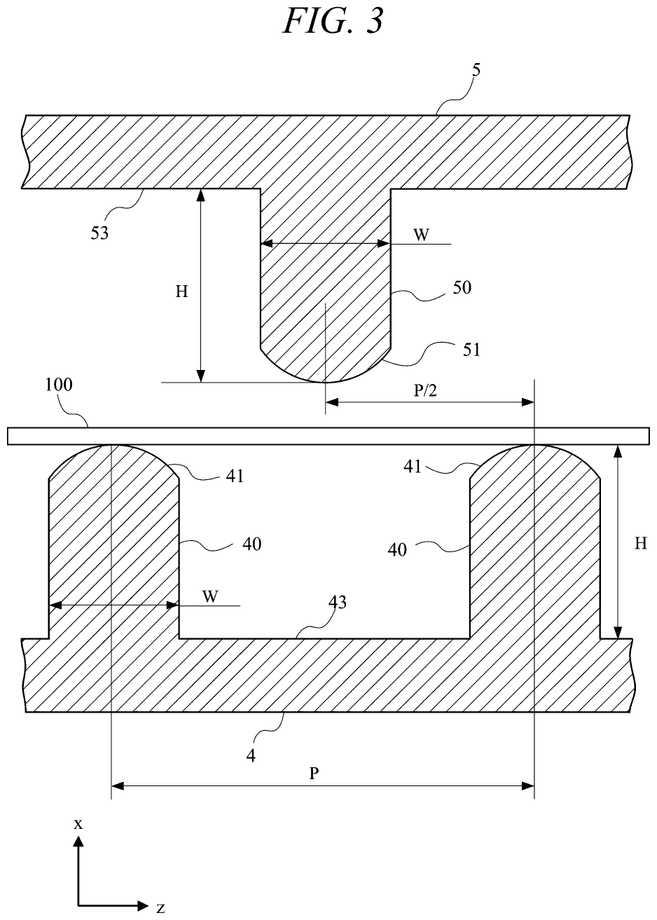

FIG. 3 is a diagram illustrating a cross-sectional shape of a first press mold used in the pre-forming process. The first press mold includes a mold (hereinafter, referred to as a die) 4 on which a thin metal plate 100 (corresponding to the thin plate PL1 or PL2) as a workpiece to be machined is set, and a mold (hereinafter, referred to as a punch) 5, which moves toward the die 4 to press the thin metal plate 100.

On each the die 4 and the punch 5, a plurality of protrusion portions 40 and 50 for pressing the thin metal plate 100 are respectively provided. The protrusion portion 40 of the die 4 is formed to protrude toward the punch 5 from a flat surface portion (a die flat surface portion) 43, which faces the punch 5. The protrusion portion 50 of the punch 5 is formed to protrude toward the die 4 from a flat surface portion (a punch flat surface portion) 53, which faces the die 4.

As described above, the protrusion portions 24a and 25a and the recess portions 24b and 25b of the separators 12 and 13 have shapes inverted from each other in x-axis direction (FIG. 2). Thus, the protrusion portion 40 of the die 4 and the protrusion portion 50 of the punch 5 are configured to have identical shapes (symmetric shapes in x-axis direction). The plurality of protrusion portions 40 are disposed in z-axis direction at a predetermined pitch P. Similarly, the plurality of protrusion portions 50 are also disposed in z-axis direction at the identical pitch P to that of the protrusion portions 40. However, the protrusion portions 50 are respectively disposed to be shifted by a dimension of P/2 pitch in z-axis direction from the protrusion portions 40. H denotes the height dimension of the protrusion portions 40 and 50, and W denotes the width dimension.

A top portion of the protrusion portion 40 is formed in a convex curved surface 41, which is convex upward. In addition, a top portion of the protrusion portion 50 is formed in a convex curved surface 51, which is convex downward. In the example illustrated in FIG. 3, the convex curved surfaces 41 and 51 each have a curved surface having an arc shape in cross-section. As described above, the protrusion portions 24a and 25a and the recess portions 24b and 25b of the first and second separators 12 and 13 have symmetric shapes, and thus the convex curved surface 41 of the protrusion portion 40 and the convex curved surface 51 of the protrusion portion 50 for forming those shapes are curved surfaces having the identical shapes, but only orientations of the surfaces are different from each other.

### Description of Pre-Forming Process

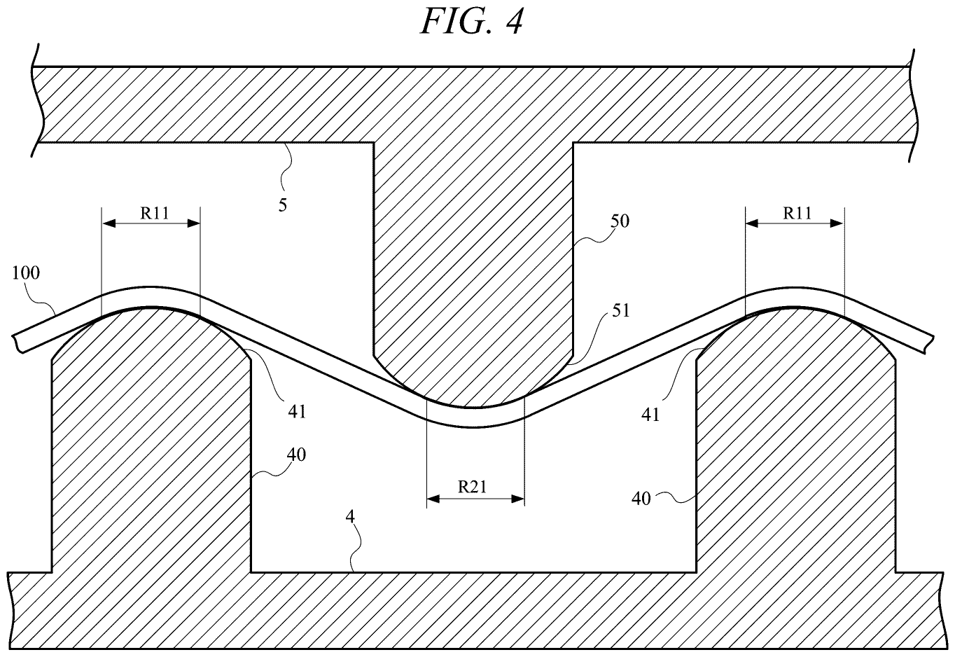

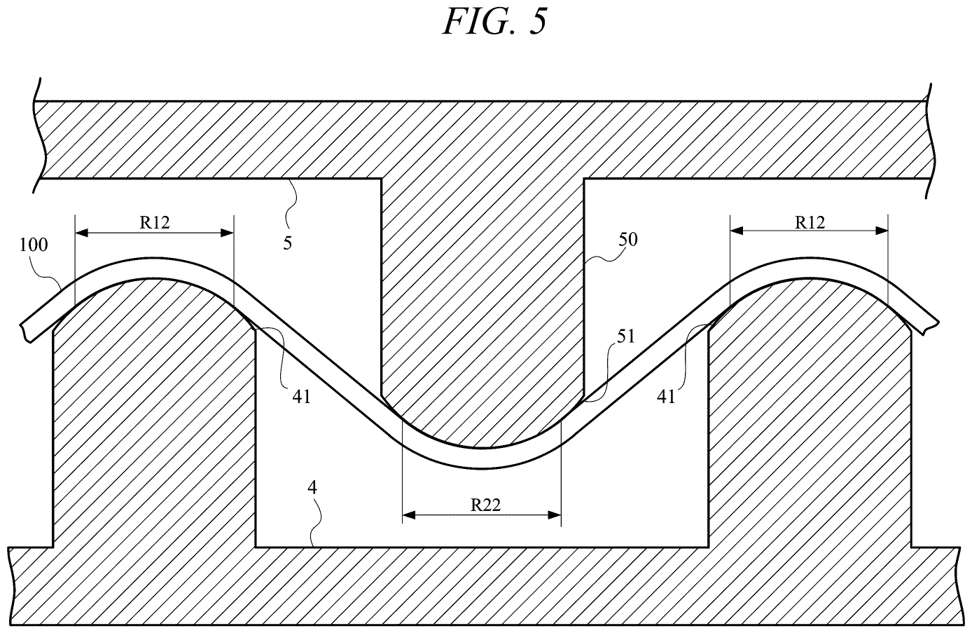

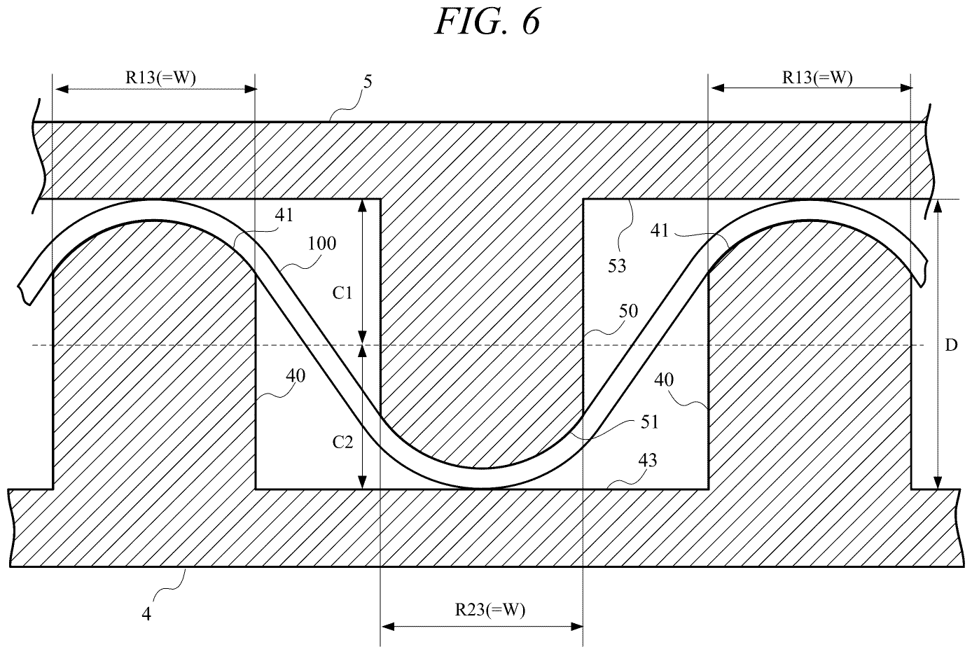

FIGS. 4 to 6 are diagrams for describing the pre-forming process. FIGS. 4 and 5 are diagrams illustrating a pressing state in the middle of the pre-forming process. On the other hand, FIG. 6 is a diagram illustrating a final pressing state in the pre-forming process. When the punch 5 is lowered toward the die 4 in the state of FIG. 3, the top portion (the convex curved surface 51) of the protrusion portion 50 abuts on an upper surface of the thin metal plate 100.

When the punch 5 is further lowered to the pressing state illustrated in FIG. 4, the thin metal plate 100 is press formed so that the material of a region R21 on which the convex curved surface 51 of the protrusion portion 50 of the punch 5 abuts and a region R11 on which the convex curved surface 41 of the protrusion portion 40 of the die 4 abuts stretch. That is, when pressing force is applied to parts on which the convex curved surfaces 41 and 51 abut, the material of such parts is mainly stretched by the pressing force, and the thickness decreases. As a result, in the thin metal plate 100, the part on which the protrusion portion 50 abuts is deformed to be convex downward, and the part on which the protrusion portion 40 abuts is deformed to convex upward.

FIG. 5 illustrates a state in which the punch 5 is further lowered from the state illustrated in FIG. 4. When the punch 5 is further lowered, the contact regions of the convex curved surfaces 41 and 51 in contact with the thin metal plate 100 are enlarged from the pressing state of FIG. 4. That is, the contact regions of the convex curved surfaces 41 and 51 are gradually enlarged, as the punch 5 is further lowered. Therefore, in FIG. 5, with regard to regions R12 and R22 in which the convex curved surface 41 of the die 4 and the convex curved surface 51 of the punch 5 abut on the thin metal plate 100, R12>R11 and R22>R21 are satisfied.

FIG. 6 illustrates the final pressing state of the pre-forming process in which the punch 5 is further lowered from the state illustrated in FIG. 5. In the state of FIG. 6, the lowering of the punch 5 is stopped by a positioning portion, not illustrated, that determines a distance D between the die 4 and the punch 5. In the thin metal plate 100 after the pre-forming, a first bulging portion C1, which is convex upward, and which includes a pressed region (a region R13) pressed by the convex curved surface 41 of the protrusion portion 40 in the top portion, and a second bulging portion C2, which is convex downward, and which includes a pressed region (a region R23) pressed by the convex curved surface 51 of the protrusion portion 50 in the top portion, are formed. Note that in the thin metal plate 100 having a wavy shape after the pre-forming, the first bulging portion C1 denotes an upper side than the center in the height direction, and the second bulging portion C2 denotes a lower side than the center in the height direction. In the pre-forming process, the regions R13 and R23 to which the pressing force is applied are mainly deformed, and the thickness of those regions is slightly decreased.

In an example illustrated in FIG. 6, the distance D from the flat surface portion 43 to the flat surface portion 53 is set to satisfy D =HO so that the height of the formed product in the pre-forming process is equal to a target height (the height of a finished product illustrated in FIG. 2). For this reason, no gap is generated between the flat surface portions 43 and 53 and the top portions of the thin metal plate 100, which has been formed in the wavy shape. In this manner, the height dimension H (FIG. 3) of the protrusion portions 40 and 50 is preferably set to satisfy D=H0. However, for example, the height dimension may be set to be slightly larger, such as H0+ΔH, so that a gap is generated between the flat surface portions 43 and 53 and the top portions of the thin metal plate 100 formed in the wavy shape.

### Configuration of Second Press Mold

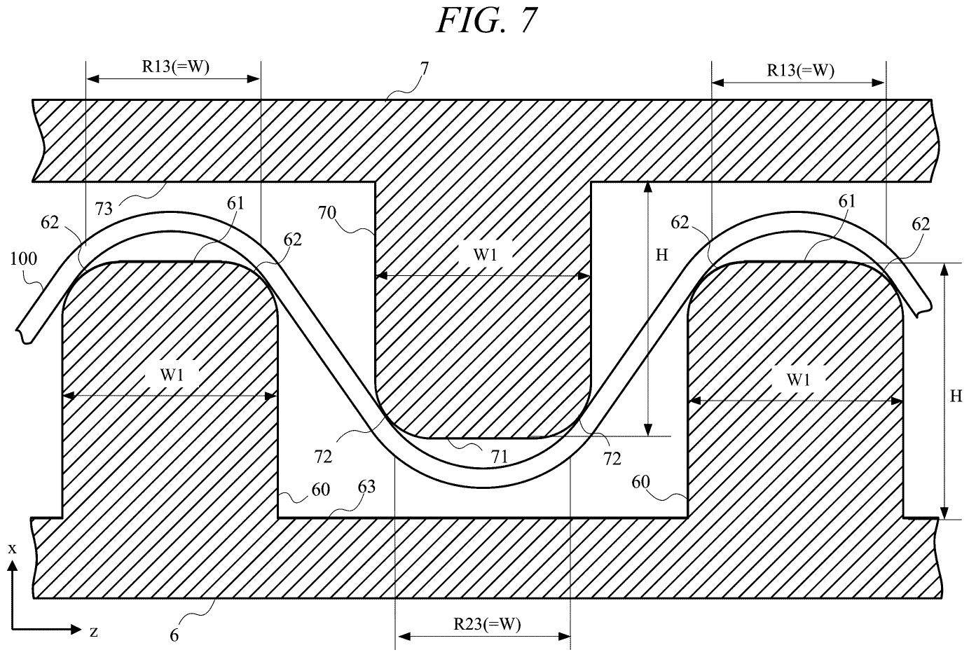

FIG. 7 is a diagram illustrating a cross-sectional shape of a second press mold used in the shape forming process. The second press mold includes a die 6 in which the thin metal plate 100 having a wavy shape after the pre-forming process ends is set, and a punch 7 which moves toward the die 6 and presses the thin metal plate 100. In order to distinguish between the first press mold (a first mold) and the second press mold (a second mold), the die 4 and the punch 5 of the first press mold will be respectively referred to as a first die and a first punch, and the die 6 and the punch 7 of the second press mold will be respectively referred to as a second die and a second punch, in some cases.

On the die 6 and the punch 7, a plurality of protrusion portions 60 and 70 for pressing the thin metal plate 100 are respectively provided. The protrusion portion 60 of the die 6 is formed to protrude toward the punch 7 from a flat surface portion 63 which faces the punch 7. The protrusion portion 70 of the punch 7 is formed to protrude toward the die 6 from a flat surface portion 73 which faces the die 6. The protrusion portion 60 of the die 6 and the protrusion portion 70 of the punch 7 are configured to have identical shapes (symmetric shapes in x-axis direction).

The plurality of protrusion portions 60 are disposed in z-axis direction at the identical pitch P in a similar manner to the case of the die 4. The plurality of protrusion portions 70 are also disposed in z-axis direction at the identical pitch P to that of the protrusion portions 60. In addition, the protrusion portions 70 are respectively disposed to be shifted by P/2 pitch in z-axis direction from the protrusion portions 60. H denotes the height dimension of the protrusion portions 60 and 70, and W1 denotes the width dimension.

The top portion of the protrusion portion 60 includes a flat surface portion 61, and curved surface portions 62 provided at both ends of the flat surface portion 61 in z-axis direction. In addition, the top portion of the protrusion portion 70 includes a flat surface portion 71, and curved surface portions 72 provided at both ends of the flat surface portion 71 in z-axis direction. The shapes of the protrusion portions 60 and 70 are identical to each other. In a case where the protrusion portion 60 is inverted in x-axis direction, it becomes the protrusion portion 70.

On the die 6, the thin metal plate 100 having a wavy shape, after the pre-forming process (FIG. 6) ends, is set as illustrated in FIG. 7. The region R13 in the thin metal plate 100 having the wavy shape is a region that has been pressed by the protrusion portion 40 of the die 4 in the pre-forming process. In addition, the region R23 is a region that has been pressed by the protrusion portion 50 of the punch 5 in the pre-forming process. In the regions R13 and R23 which have been respectively pressed by the protrusion portions 40 and 50, a decrease in thickness of the thin metal plate 100 due to the forming is larger than that in any region that is not pressed.

A width dimension W1 of the protrusion portion 60 of the die 6 used in the shape forming process is set so that the curved surface portions 62, which are formed at both ends in z-axis direction of the flat surface portion 61, respectively abut on regions outside the region R13 of the thin metal plate 100, that is, outer regions (regions where a decrease in thickness in the pre-forming process is relatively small). That is, it is set to satisfy W1 >W. Similarly to the case of the protrusion portion 60, the width dimension of the protrusion portion 70 of the punch 7 is set to satisfy W1 (>W), and the curved surface portions 72 at both ends in z-axis direction of the flat surface portion 71 abut on regions outside the region R23 of the thin metal plate 100, that is, outer regions.

### Description of Shape Forming Process

When the punch 7 is lowered toward the die 6 in FIG. 7, the curved surface portions 72 at both ends of the top portion of the protrusion portion 70 abut on, and are pressed against the outer regions of the region R23 of the thin metal plate 100 having a wavy shape. The curved surface portions 72 of the punch 7 respectively abut on the outer regions of the region R23 on recess surfaces of the downwardly protruding bulging portion (the second bulging portion C2) having the region R23 as a top portion. Similarly, the curved surface portions 62 at both ends of the top portion of the protrusion portion 60 of the die 6 respectively abut on, and are pressed against the outer regions of the region R13 of the thin metal plate 100 having a wavy shape. The curved surface portion 62 of the die 6 abuts on the outer regions of the region R13 on recess surfaces of the upwardly protruding bulging portion (the first bulging portion C1) having the region R13 as a top portion.

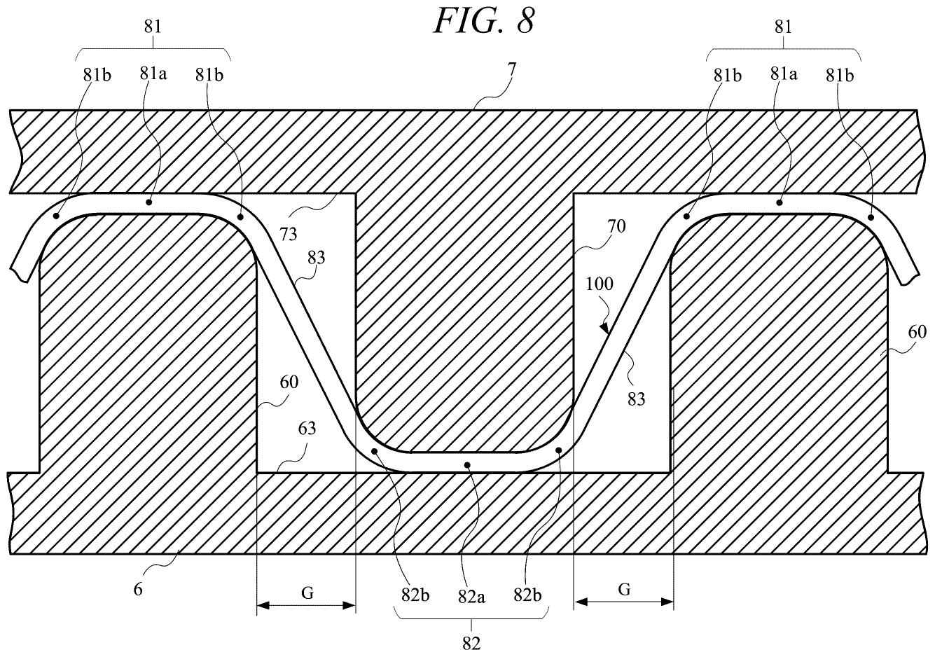

When the punch 7 is further lowered, the region R23, which faces the flat surface portion 71 of the protrusion portion 70, that is, the top portion of the second bulging portion C2 is sandwiched between the flat surface portion 63 of the die 6 and the flat surface portion 71, and is flattened. Also, in the region R13, which faces the flat surface portion 61 of the protrusion portion 60, similarly to the case of the region R23, the first bulging portion C1 is sandwiched between the flat surface portion 61 and the flat surface portion 73, and is flattened. Finally, the punch 7 is lowered to the position illustrated in FIG. 8, and the shape forming process ends. The thin metal plate 100 is formed in the identical uneven shape to the uneven groove surfaces 24 and 25 illustrated in FIG. 2.

In the shape forming process, the thickness decreases mainly in a region where the thin metal plate 100 is pressed by the curved surface portions 62 and 72. The thin metal plate 100 is formed in a wavy shape in the pre-forming process, and thus the moving distance of the punch 7 from the start of the forming in FIG. 7 to the end of the forming in FIG. 8 is smaller than the moving distance of the punch 5 in the pre-forming process. In addition, the regions pressed by the curved surface portions 62 and 72 are respectively located outside the regions R13 and R23, and thus the decrease in thickness in the pre-forming process is very small. Therefore, it becomes possible to suppress a decrease in thickness of the regions pressed by the curved surface portions 62 and 72 in all processes including the pre-forming process and the shape forming process. Further, in the region R13 or R23 in FIG. 7 between the curved surface portions 62 and 62 or between the curved surface portions 72 and 72, the thin metal plate 100 is sandwiched between the pressed regions of the curved surface portions 62 and 62 or curved surface portions 72 and 72, and is prevented from moving to the outside, and thus the change in thickness of the thin metal plate 100 is very small.

As described above, in the shape forming process, the thickness of the thin metal plate 100 is decreased mainly in the regions respectively pressed by the curved surface portions 62 and 72. The curved surface portions 62 and 72 respectively press the outer regions of the regions R13 and R23. Therefore, in the shape forming process, it becomes possible to form the shape of the thin metal plate 100, while suppressing a decrease in thickness of the regions R13 and R23 in which the thickness has been decreased by the pre-forming process.

As illustrated in FIG. 8, the finished product after the shape forming process includes a top portion 81 formed to correspond to the flat surface portion 61 and the curved surface portions 62 of the protrusion portion 60 of the die 6 (see FIG. 7), a top portion 82 formed to correspond to the flat surface portion 71 and the curved surface portions 72 of the protrusion portion 70 of the punch 7 (see FIG. 7), and a side wall portion 83 which couples the top portion 81 with the top portion 82. Flat portions 81a and 82a of the top portions 81 and 82 are respectively formed by flattening the curved surface portions in the regions R13 and R23 which have been formed in the pre-forming, and the thickness hardly changes in the shape forming process. R-shaped portions 81b and 82b at both ends of the top portions 81 and 82 are formed in the shape forming process.

In this manner, the respective portions of the top portions 81 and 82 of the finished product are formed in the pre-forming process or the shape forming process. That is, the top portions 81 and 82 correspond to pressed regions in the press forming in the present embodiment. The decrease in thickness due to the forming is dispersed over the entirety of the top portions 81 and 82, and a local decrease in thickness is suppressed. In addition, no pressing force is applied to the side wall portion 83 in the pre-forming process and the shape forming process, so that a decrease in thickness of the side wall portion 83 can be suppressed as much as possible. A part to which no pressing force is applied is achieved by forming a gap G (see FIG. 8), which does not press the thin metal plate 100 between the protrusion portion 60 of the die 6 and the protrusion portion 70 of the punch 7 in the pre-forming process or the shape forming process. That is, since the gap G is formed, a region (the side wall portion 83) to which no pressing force is applied is generated between the top portions 81 and 82 (the pressed regions in the press forming in the present embodiment) separated from each other.

As described heretofore, according to the press forming method in the present embodiment, it becomes possible to suppress a decrease in thickness of the side wall portion 83, and it also becomes possible to suppress the entire degree of the decrease in thickness of the finished product. As a result, the machining accuracy in the press forming can be improved, and the thickness inspection can be omitted.

Note that the sizes of the regions R13 and R23 to which the pressing force is applied in the pre-forming process are preferably set as large as possible for the purpose of dispersing the decrease in thickness. Specifically, the width dimension W of the protrusion portions 40 and 50 of the die 4 and the punch 5 is preferably set so that the boundaries of the regions R13 and R23 illustrated in FIG. 7 are located in the inside of the curved surface portions 62 and 72 of the protrusion portions 60 and 70 and in the vicinity of them.

In addition, in the above-described embodiments, the shapes of the convex curved surfaces 41 and 51, which are respectively formed at the top portions of the protrusion portions 40 and 50, have been described with an example of the convex curved surface having an arc shape in cross-section. However, it is possible to set various shapes of the convex curved surfaces. For example, in a case where the cross-section has a sinusoidal shape (a shape of the peak region of a sinusoidal curved surface), the effect of suppressing the decrease in thickness in the regions R13 and R23 is large. Therefore, the convex curved surfaces 41 and 51 each may have a sinusoidal shape.

The various embodiments and modifications described above are merely exemplary, and the present invention is not limited to these configurations insofar as the features of the invention are not impaired. Other variations and arrangements that can be conceived within the scope of the technical concept of the present invention are also included within the scope of the present invention.

### REFERENCE SIGNS LIST

4 die, 5 punch, 10 power generation cell, 11 unitized electrode assembly, 12 first separator, 13 second separator, 24, 25 uneven groove surface, 24 a, 25 a, 40, 50, 60, 70 protrusion portion, 24b, 25b recess portion, 41, 51 convex curved surface, 43, 53, 61, 63, 71, 73 flat surface portion, 62, 72 curved surface portion, 81, 82 top portion, 81a, 82a flat portion, 81b, 82b R-shaped portion, 83 side wall portion, 100 thin metal plate, C1, C2 bulging portion, R11, R12, R13, R21, R22, R23 region

1-6. (canceled)

7. A press forming method for a metal plate comprising:
a pre-forming step of pressing a metal plate with a convex curved surface to form a bulging portion having a pressed region pressed by the convex curved surface in a top portion; and
a shape forming step of pressing outer regions on both sides of the pressed region in the bulging portion to flatten the top portion, and forming the metal plate having the top portion flattened, and a side wall portion contiguous to the top portion and not subjected to pressing, wherein
the pre-forming step includes forming the bulging portion having a height equal to a target height of the metal plate after the shape forming step.

8. The press forming method for the metal plate according to claim 7, wherein
the pre-forming step includes:
pressing a first surface of the metal plate with a protrusion portion of a first die to form a first bulging portion protruding from a second surface of the metal plate;
pressing the second surface of the metal plate with a protrusion portion of a first punch, in a region different from the pressed region spaced apart from the pressed region, to form a second bulging portion protruding from the first surface of the metal plate; and
forming the convex curved surfaces on both top portions of protrusion portions of the first die and the first punch.

9. The press forming method for the metal plate according to claim 8, wherein
the shape forming step includes:
press-forming the metal plate with a second die and a second punch, the second die having a protrusion portion with a top surface formed to be flat and protruding from a flat portion of the second die, the second punch having a protrusion portion with a top surface formed to be flat and protruding from a flat portion of the second punch;
while restricting the first bulging portion to the target height by the flat portion of the second punch, pressing the outer regions on a concave side surface of the first bulging portion at both ends of the top surface of the protrusion portion of the second die; and
while restricting the second bulging portion to the target height by the flat portion of the second die, pressing the outer regions on a concave side surface of the second bulging portion at both ends of the top surface of the protrusion portion of the second punch.

10. The press forming method for the metal plate according to claim 8, wherein
a curved surface shape of the convex curved surfaces formed on the protrusion portions of the first die and the first punch is set to a shape of a peak region of a sinusoidal curved surface.

11. A press apparatus configured to perform the press forming method for the metal plate according to claim 7, comprising:
a first mold used in the pre-forming step; and
a second mold used in the shape forming step, wherein
the first mold includes
a first die having a first protrusion portion with a top surface formed to be the convex curved surface and protruding from a flat portion of the first die, and
a first punch having a first protrusion portion with a top surface formed to be the convex curved surface and protruding from a flat portion of the first punch, and the second mold includes
a second die having a second protrusion portion with a top surface formed to be a flat surface and protruding from a flat portion of the second die, and
a second punch having a second protrusion portion with a top surface formed to be a flat surface and protruding from a flat portion of the second punch.

12. The press forming method for the metal plate according to claim 7, wherein the metal plate forms a separator of a fuel cell.
